(19) United States
(12) Patent Application Publication
(10) Pub. No.: US 2011/0062252 A1
(43) Pub. Date: Mar. 17, 2011

(54) NON-REUSABLE DISPOSABLE SPRAY CONTAINER

(76) Inventors: SIMONA BUNIN, Parkland, FL (US); Sherene Costanzo, Parkland, FL (US); Frank Ko, Jiangsu (CN)

(21) Appl. No.: 12/561,323

(22) Filed: Sep. 17, 2009

(51) Int. Cl. B05B 9/03

(52) U.S. Cl. 239/302; 222/372

(57) ABSTRACT

A disposable spray assembly is disclosed. The disposable spray assembly includes a container for holding a liquid, the container having a neck portion, a ring coupled to an exterior surface of the neck portion, the ring having an increasing outer diameter in a downwards direction, a spray mechanism for expelling the liquid, the spray mechanism coupled with the neck portion and having a hilt that rests upon a top of the neck portion and a collar element for placement around the neck portion under the ring, wherein an inner diameter of the collar element is equal to or larger than an exterior diameter of a top portion of the ring but smaller than an exterior diameter of a bottom portion of the ring such that upon placement of the inner diameter of the collar element around the neck portion underneath the ring, the collar element cannot be removed from the neck portion.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

This invention relates to disposable containers, and more particularly to disposable containers that cannot be reused.

### BACKGROUND OF THE INVENTION

Spray containers have been available commercially for many years. Spray bottles, for example, are used to dispense a variety of liquid products ranging from hair products to culinary accoutrements. Further, various incarnations of the spray bottle exists. Early forms of the spray bottle included a bottle filled with a liquid product as well as a high pressure gas such that the liquid product was expelled when a spray button was depressed. Another form of a spray bottle eliminates the use of pressurized gas but rather utilizes the pressure created when the spray button is pressed by the user to expel the liquid product inside the bottle. Yet another type of spray bottle includes a pump mechanism that allows a user to pump a shaft to increase the pressure inside the bottle, thereby creating the pressure needed to expel the liquid product when the spray button is pressed.

One problem with spray bottles, and other types of containers for disposable products, is that consumers tend to reuse the container. For example, a consumer may enjoy a disposable spray bottle enough to refill the spray bottle with the liquid product, or a lower cost alternative, thereby reusing the container. This is disadvantageous because refilled containers, depending upon the liquid filled, tend to clog the nozzle of the spray button, causing consumers to lose confidence in the container. This is also disadvantageous for the manufacturer because a loss of consumer confidence tends to disparage the container's capabilities through no fault of its own. A further disadvantage for the manufacturer of the disposable spray bottle and/or the manufacturer of the liquid product when a consumer tries to refill it is that it discourages the consumer from buying additional units of the disposable product. That is, after the first sale of the disposable product to the consumer, the consumer may reuse the disposable container and thereby refrain from buying additional units of the disposable product at a later date.

One of the sources of the above problem is the method in which the spray bottle or other container is manufactured or assembled. Typically, the spray bottle or container consists of a bottle or container with a neck portion having an exterior threaded area. The spray and/or pump mechanism includes an interior threaded area that simply screws onto the neck portion of the bottle or container. Such an embodiment makes it very easy for a consumer to unscrew the spray and/or pump mechanism to refill the bottle or container for reuse.

Therefore, there is a need to traverse the deficiencies in the art and more particularly there is a need for a disposable spray container with pump and spray features that encourage consumers to buy additional products after the first sale.

### SUMMARY OF THE INVENTION

Briefly, in accordance with one embodiment of the present invention, a disposable spray assembly is disclosed. The disposable spray assembly includes a container for holding a liquid, the container having a neck portion, a ring coupled to an exterior surface of the neck portion, the ring having an increasing outer diameter in a downwards direction, a spray mechanism for expelling the liquid, the spray mechanism coupled with the neck portion and having a hilt that rests upon a top of the neck portion and a collar element for placement around the neck portion under the ring, wherein an inner diameter of the collar element is equal to or larger than an exterior diameter of a top portion of the ring but smaller than an exterior diameter of a bottom portion of the ring such that upon placement of the inner diameter of the collar element around the neck portion underneath the ring, the collar element cannot be removed from the neck portion.

In another embodiment of the present invention, an alternative disposable spray assembly is disclosed. The disposable spray assembly includes a container for holding a liquid, the container having a neck portion, a ring coupled to an exterior surface of the neck portion, the ring having an increasing outer diameter in a downwards direction, a spray mechanism for expelling the liquid, the spray mechanism coupled with the neck portion and having a hilt that rests upon a top of the neck portion and a collar element for placement around the neck portion under the ring, the collar element including a gutter disposed along an inner diameter of the collar element, wherein the gutter is shaped so as to accommodate a shape of the ring, such that upon placement of the collar element around the neck portion, the collar element cannot be removed from the neck portion.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 shows an exploded view depicting the various components of a disposable spray product including a container for holding a liquid product, according to one embodiment of the present invention.

FIG. 2 shows a cross section of the disposable spray product in an assembled state, according to one embodiment of the present invention

### DETAILED DESCRIPTION

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawing, like numerals refer to like parts through several views.

The present invention, according to a preferred embodiment, overcomes problems with the prior art by providing a disposable spray container with pump and spray features while restricting the ability to refill the spray container with the liquid product after it has been dispensed. These features discourage the reuse of the spray container and thereby encourage the consumer to purchase additional units of the disposable spray container after the contents of the already purchased unit have been exhausted.

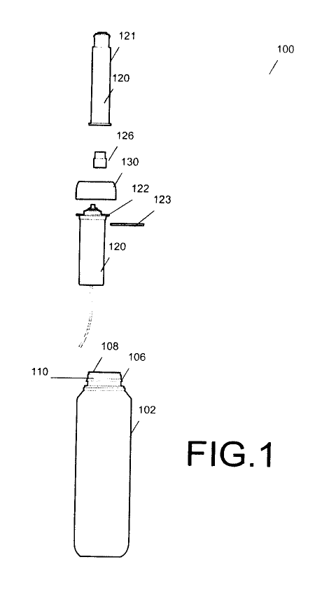

FIG. 1 shows an exploded view depicting the various components of a disposable spray product 100 including a container 102 for holding a liquid product, such as a hair product, a culinary accouterment or a cleaning agent. The container 102 may include a neck portion 106 located at the top of the container 102 and including an opening 108 that allows access to an interior volume of the container 102.

The neck portion 106 includes a ring 110 coupled to and surrounding an exterior surface of the neck portion 106. The ring 110 includes an increasing outer diameter in a downwards direction. Thus, the cross section of the ring 110 shows that the ring 110 widens as the ring 110 extends downwards towards the bottom of the container 102, reflecting a pointed shape. The ring 110 may be integrally formed with the neck portion 106, or the ring 110 may be a separate element that is coupled with the neck portion 106 via an adhesive or another technique.

FIG. 1 further shows a pump and spray mechanism 120 for increasing pressure within the container 102 and spraying out the liquid product. The pump mechanism 120 includes a hilt 122 that rests upon a top of the neck portion 106. Note that hilt 122 includes an outer diameter that is substantially commensurate with the outer diameter of the neck portion 106. Preferably, the hilt 122 includes an outer diameter that is greater than or equal to the outer diameter of the opening 108 of the neck portion 106 such that the hilt 122 rests upon the top of the neck portion 106 and keeps the pump and spray mechanism 120 from falling inside the container 102. FIG. 1 also shows a washer 123 that rests between the hilt 122 and the top of the neck portion 106. Note that washer 123 includes an outer diameter that is substantially commensurate with the outer diameter of the hilt 122. Preferably, the washer 123 includes an outer diameter that is greater than or equal to the outer diameter of the hilt 122 while being greater than the diameter of the opening 108 of the neck portion 106 such that the washer 123 rests between the top of the neck portion 106 and the hilt 122 so as to provide a water tight seal between the pump and spray mechanism 120 and the container 102.

The pump and spray mechanism 120 may include a pump comprising a shaft 121 that is manually pumped in a vertical direction to increase pressure within the container 102. The pump and spray mechanism 120 may also include a spray button 126 that when pressed releases the liquid product within the container 102 in a spray mist.

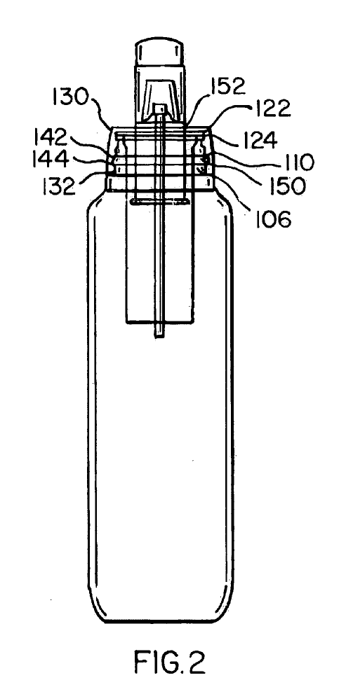

FIGS. 1 and 2 also show a collar element 130 for placement around the neck portion 106 and around the ring 110. An inner diameter 132 of the collar element 130 is equal to or larger than an exterior diameter 142 of a top portion of the ring 110 but smaller than an exterior diameter 144 of a bottom portion of the ring 110 such that once snapped in place on the neck portion 106 around the ring 110, the collar element 130 cannot be removed from the neck portion 106.

The collar element 130 also shows a gutter 150 disposed along an inner diameter of the collar element 130, wherein the gutter 150 is shaped so as to accommodate a shape of the ring 110, thereby securing the ring 110 within the collar element 130 when the collar element 130 is placed around the neck portion 106.

The collar element 130 may also include a second inner diameter 152 on a top portion of the collar element 130. The second inner diameter 152 rests upon a top of the hilt 122, wherein the second inner diameter 152 is smaller than an outer diameter of the hilt 122 so as to secure the pump and spray mechanism 120 to the neck portion 106 when the collar element 130 is placed around the neck portion 106.

One or more of the components of the disposable spray product 100 can be manufactured from a flexible or elastic material such as plastic. An elastic material is defined as a material that can be deformed or bent out of shape when subject to an exterior force but returns to its original shape or length when the exterior force is removed. In this way, collar element 130 and/or ring 110 can be manufactured from a flexible or elastic material, thereby allowing the collar element 130 to fit over the ring 110 to eventually rest around the ring 110, when the collar element 130 is placed over the ring 110 and pressure is applied by a person or a machine in a downwards direction. In this scenario, the inner diameter 132 of the collar element may be substantially commensurate with or slightly smaller than the exterior diameter 144 of the bottom portion of the ring 110 such that one or both of the elements (the collar element 130 and ring 110) slightly and temporarily deforms out of shape/diameter to allow the collar element 130 to fit over the ring 110 when the collar element 130 is pushed or pressed into place over the ring 110. Consequently, once the collar element 130 is pushed in place around the ring 110, one or both of the elements (the collar element 130 and ring 110) returns to its original shape/diameter.

Once the collar element 130 rests around the ring 110, and one or both elements returns to its original shape/diameter, then the collar element 130 is secure on the neck portion 106 and cannot be removed without damaging, cutting or splitting one or more of the elements of the disposable spray product 100. As such, once the liquid product inside container 102 is expended, the consumer cannot easily refill and reuse the disposable spray product 100 and the consumer is encouraged to purchase additional units of the disposable spray product 100.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A disposable spray assembly, comprising:
a container for holding a liquid, the container having a neck portion;
a ring coupled to an exterior surface of the neck portion, the ring having an increasing outer diameter in a downwards direction;
a spray mechanism for expelling the liquid, the spray mechanism coupled with the neck portion and having a hilt that rests upon a top of the neck portion; and
a collar element for placement around the neck portion under the ring, wherein an inner diameter of the collar element is equal to or larger than an exterior diameter of a top portion of the ring but smaller than an exterior diameter of a bottom portion of the ring such that upon placement of the inner diameter of the collar element around the neck portion underneath the ring, the collar element cannot be removed from the neck portion.

2. The disposable spray assembly of claim 1, further comprising:
a second inner diameter of the collar element, which rests upon a top of the hilt, wherein the second inner diameter is smaller than an outside diameter of the hilt, so as to secure the spray mechanism to the neck portion.

3. The disposable spray assembly of claim 2, further comprising:
a gutter disposed along an inner diameter of the collar element, wherein the gutter is shaped so as to accommodate a shape of the ring, thereby securing the ring within the collar element when the collar element is placed around the neck portion.

4. The disposable spray assembly of claim 1, wherein the spray mechanism includes a pump mechanism including a shaft that is manually pumped in a vertical direction to increase pressure within the container.

5. The disposable spray assembly of claim 4, wherein the spray mechanism includes a spray button that when depressed releases the liquid within the container in a spray mist.

6. The disposable spray assembly of claim 1, wherein the neck portion and the collar element are composed of an elastic material such as plastic.

7. A disposable spray assembly, comprising:
a container for holding a liquid, the container having a neck portion;
a ring coupled to an exterior surface of the neck portion, the ring having an increasing outer diameter in a downwards direction;
a spray mechanism for expelling the liquid, the spray mechanism coupled with the neck portion and having a hilt that rests upon a top of the neck portion; and
a collar element for placement around the neck portion under the ring, the collar element including a gutter disposed along an inner diameter of the collar element, wherein the gutter is shaped so as to accommodate a shape of the ring, such that upon placement of the collar element around the neck portion, the collar element cannot be removed from the neck portion.

8. The disposable spray assembly of claim 7, further comprising:
a second inner diameter of the collar element, which rests upon a top of the hilt, wherein the second inner diameter is smaller than an outside diameter of the hilt, so as to secure the spray mechanism to the neck portion.

9. The disposable spray assembly of claim 7, wherein the spray mechanism includes a pump mechanism including a shaft that is manually pumped in a vertical direction to increase pressure within the container.

10. The disposable spray assembly of claim 9, wherein the spray mechanism includes a spray button that when depressed releases the liquid within the container in a spray mist.

11. The disposable spray assembly of claim 7, wherein the neck portion and the collar element are composed of an elastic material such as plastic.

12. The disposable spray assembly of claim 7, further comprising a washer therebetween said hilt and said neck portion, and having an outer diameter that is substantially commensurate with the outer diameter of said hilt.
